(19) United States
(12) Patent Application Publication
(10) Pub. No.: US 2011/0050755 A1
(43) Pub. Date: Mar. 3, 2011

(54) ELECTRICAL DEVICE WITH SELECTIVELY REFLECTIVE DISPLAY

(76) Inventors: Alan Amron, Miami Beach, FL (US); Richard Grobman, Hewlett, NY (US); Eric T. Brewer, Saratoga, CA (US)

(21) Appl. No.: 12/873,196

(22) Filed: Aug. 31, 2010

Related U.S. Application Data
(60) Provisional application No. 61/238,600, filed on Aug. 31, 2009.
(60) Provisional application No. 61/304,997, filed on Feb. 16, 2010.

(51) Int. Cl. G09G 5/10

(52) U.S. Cl. 345/690

(57) ABSTRACT

An electrical device in accordance with an embodiment of the present application includes a display in which the reflectivity of the display is alterable to allow the display to display information to the user and to serve as a mirror for the user.

### CROSS-REFERENCE TO RELATED APPLICATIONS

The present application claims benefit of and priority to U.S. Provisional Patent Application Ser. No. 61/238,600 filed Aug. 31, 2010 entitled ELECTRICAL DEVICE WITH SELECTIVELY REFLECTIVE DISPLAY and U.S. Provisional Patent Application Ser. No. 61/304,997 filed Feb. 16, 2010 entitled SMART PROTECTOR CASE, the entire content of each of which is hereby incorporated by reference herein.

### BACKGROUND

1. Field of the Disclose

The present disclosure relates to an electrical device including a display device that is selectively usable as a mirror. More particular, the present application relates to an electrical device that includes a display in which reflectivity can be selectively changed such that it may act as a mirror.

2. Related Art

Portable electrical or electronic devices such as cellular telephones have become almost a required accessory in today's world. While these devices aid users in various fields such as communication and entertainment, they also present an additional burden in that it is just one more item that the user must carry around with them. Thus, to the extent possible, accessories that are used in everyday life should be combined.

Accordingly, it would be beneficial to provide an electrical device that may also be used as a mirror.

### SUMMARY

It is an object of the present disclosure to provide an electrical device with a display that is selectively reflective such that is usable to both display information and as a mirror, when desired.

An electrical device in accordance with an embodiment of the present application includes a controller configured and operable to control the electrical device and a display configured and operable to display information to the user, wherein reflectivity of the display is increased based on operation of the controller such that the display is usable as a mirror.

A method of controlling an electrical device including a display in accordance with an embodiment of the present application includes increasing a reflectivity of the display such that the display is usable as a mirror.

A display for use in an electrical device in accordance with an embodiment of the present application includes a controller to control display of information to a user on the display and to selectively increase reflectivity of the display such that the display is usable as a mirror.

Other features and advantages of the present invention will become apparent from the following description of the invention which refers to the accompanying drawings.

### BRIEF DESCRIPTION OF THE DRAWINGS

FIG. 1 is a schematic illustration of an electrical device in accordance with an embodiment of the present disclosure;

FIG. 2 is an exemplary block diagram of a display of the electrical device of FIG. 1 in accordance with an embodiment of the present disclosure;

FIG. 2A is an exemplary cross section of a reflective material suitable for use in the electrical device of FIGS. 1-2;

FIG. 3 is an exemplary block diagram of a display of the electrical device of FIG. 1 in accordance with another embodiment of the present disclosure;

FIG. 4 is a schematic illustration of an electrical device including an external reflective element in accordance with an embodiment of the present disclosure;

FIG. 5 is an exemplary block diagram of a display of an electrical device in accordance with an embodiment of the present disclosure;

FIG. 5A is an exemplary cross sectional view of an LCD display;

FIG. 6 illustrates an exemplary cross-section of the display device of FIG. 5;

FIG. 7 is a schematic illustration of a display of an electrical device in accordance with an embodiment of the present disclosure; and

FIG. 7A is an illustration of an electrical device in accordance with another embodiment of the present disclosure.

FIG. 8 is an illustration of an electrical device in accordance with another embodiment of the present disclosure.

### DETAILED DESCRIPTION OF THE EMBODIMENTS

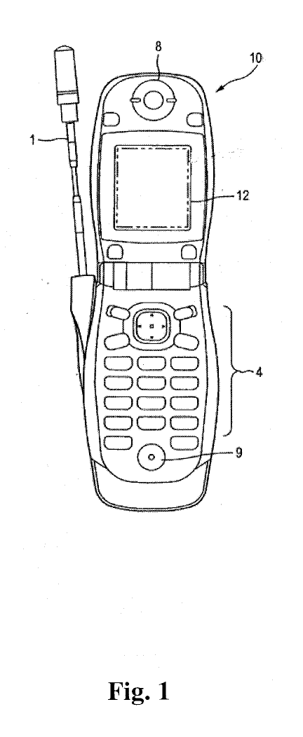

An electrical device 10 in accordance with an embodiment of the present disclosure is illustrated in FIG. 1. The device 10 includes a display device 12 that is operable to display information to a user and is selectively adjustable to increase its reflectivity such that it can also be used as a mirror. While illustrated as a cellular telephone in FIG. 1, the electrical device 10 may be any electrical device, including but not limited to, a cellular telephone, smart phone, PDA, laptop computer, media playing device or even a monitor of a personal computer system, if desired. The device 10 preferably also includes a speaker 8, an antenna 1, a plurality of user input keys or buttons 4 and a microphone 9. Other elements may also be provided including a camera, for example.

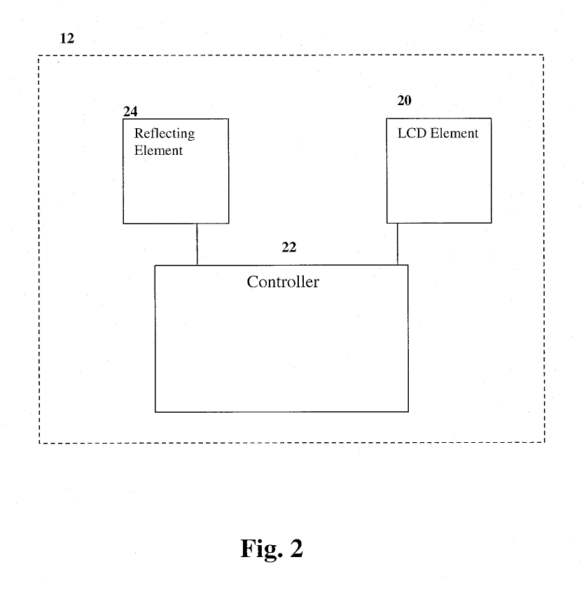

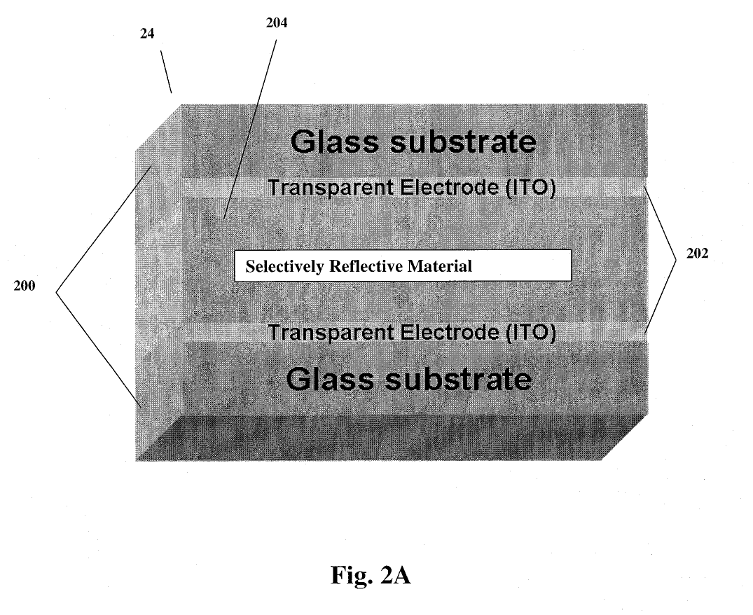

In accordance with one embodiment, illustrated in the block diagram of FIG. 2, for example, the display 12 includes a liquid crystal display (LCD) element 20 which is controlled by a controller 22 to display information to a user as desired. The controller 22 may be the same controller utilized to control the function of the device 10 as a whole, or may be dedicated to control of the display 12, if desired. A reflecting element 24 is preferably positioned in front of the LCD element 20, that is, between the LCD element and the user. The reflecting element 24 is preferably also controlled by the controller 22 to selectively change reflectivity such that it is substantially transparent when the LCD element 20 is actively displaying information to the user and is substantially reflective when the LCD element is not displaying information, such that a user can see their own reflection in the display 12. Alternatively, a separate control circuit may be provided for the element 24. In a preferred embodiment, the controller 22 will control the device 10, display 12 and/or the reflecting element 24 based on executable instructions provided in memory or removable memory device. These instructions may be a part of a software application, for example.

While the display 12 of FIG. 1 refers to an LCD element 20, it is noted that the display need not be limited to an LCD type display. Any suitable display may be used including, but not limited to organic light emitting diode (OLED) displays and e-paper displays. That is, the element 20 may be an OLED element or an e-paper element, if desired. Indeed, the display 12 may utilize any suitable display technology to display information to a user.

The reflecting element 24 preferably includes a material that will change reflectivity based upon a voltage, or other signal, applied thereto. Preferably, reflectivity is changed based on a voltage applied via translucent electrodes that apply an electric field across the material. Varying the voltage applied will vary the reflectivity of the reflecting element 24 such that it can operate as a mirror when desired. In one embodiment, when no voltage is applied, the element 24 reflects a large percentage of the light received from the exterior of the device 10, such that it functions as a mirror. When it is desirable to use the display 12 to view information, a voltage is applied to the element 24 such that it becomes substantially transparent and the information displayed on the LCD element 20 is visible to the user.

In one embodiment, the reflecting element 24 may be made of a material whose reflective and transmissive properties are varied based on application of an electric field. The reflector, may be a transition-metal switchable mirror, for example. One example of such a transition metal switchable mirror is described in U.S. Pat. No. 6,647,166 entitled ELECTROCHROMIC MATERIALS, DEVICES AND METHOD OF MAKING, the entire content of which is hereby incorporated herein by reference. FIG. 2A illustrates a cross sectional view of an exemplary reflecting element 24 suitable for use in the electric device 10. As illustrated, two glass substrates 200 are used to sandwich two transparent electrode panels 202 that surround a material 204 that reacts to the application of an electric field to modify its transmissive and reflective properties. Translucent plastic or another polymer may be used in place of glass in the substrates 200, if desired. The material 204 is preferably bistable and electrochromic such that its reflectivity changes based on exposure to electricity or an electric field and then remains in the changed state even after the electric field is removed.

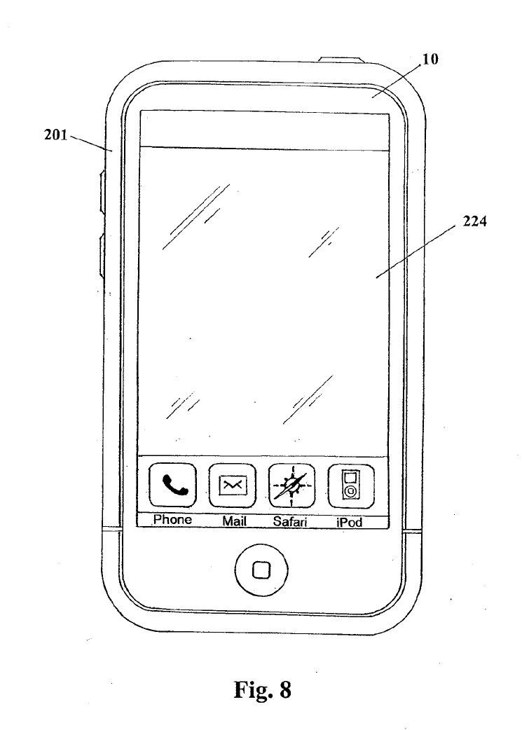

In a preferred embodiment, the material 204 is an electrochromic material in that it exhibits a reversible change of color when placed in an electric field. In one embodiment, the material 204 is a film including a transition metal composition that includes magnesium and generally at least one transition metal chosen from the group including Ti, V, Cr, Mn, Fe, Go, Ni, Cu, Zn, Zr, Nb, Mo, Tc, Ru, Rh, Pd, Ag, Cd, Hf, Ta, W, Re, Os, Ir, Pt, Au and Hg. The material 204 is preferably bistable such that once it changes from substantially reflective material to a substantially transparent material based on application of voltage via the electrodes 202 it will remain reflective even after the voltage is removed. Similarly, the material will change from substantially transparent material to a substantially translucent material upon application of voltage via the electrodes 202 and will remain translucent thereafter even when the voltage is removed. In one embodiment, the reflecting element 24 is built into the display 12 by the manufacturer. In another embodiment, the reflecting element may be included as an external element, as is explained below with reference to FIG. 8.

While the material 204 preferably includes magnesium and another transition metal, the present application is not necessarily limited to this particular embodiment, and any suitable combination of transition metals may be used.

In this manner, the display 12 can be controlled to act as both a display for information and as a mirror when information is not being displayed.

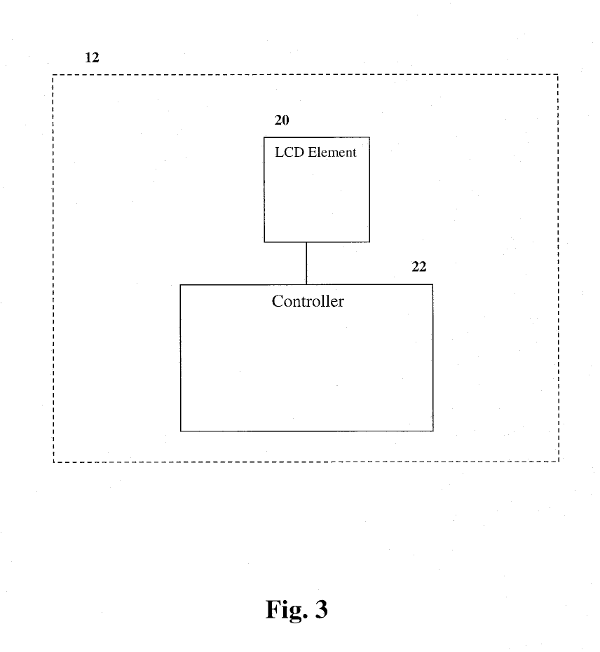

In another embodiment illustrated in FIG. 3, the LCD element 20 itself is controlled by the controller 22 to selectively alter the reflectivity thereof. As noted above, the LCD element 20 may be replaced by an OLED element or any other suitable display element. Specifically, the controller 22 will control the red (R), green (G) and blue (B) pixels of the LCD element 20 to provide a substantially reflective surface when desired. In this case, the reflecting element 24 need not be included.

In another embodiment, the LCD element 20 may include an additional pixel, preferably a silver pixel, in order to allow the controller 22 to provide a silvery reflective background on the LCD element 20 when desired. In this case, the reflecting element 24 also need not be included. As noted above, the LCD element 20 may be replaced by an OLED element, or any other suitable display element.

In another embodiment, the material used in the LCD element 20 is preferably of a type that allows for the smoothness of the material to be adjusted, for example by application of a voltage or perhaps a magnetic field. In this case, when a mirror type response is desired, the controller 22 will provide a signal that provides a smooth surface such that incoming light is reflected back out at the same angle as it arrives to provide a mirror effect. When a different signal is applied, the reflective properties will be lost and the display 12 will act as a standard LCD display. As noted above, the LCD element 20 may be replaced by an OLED element or any other suitable display element.

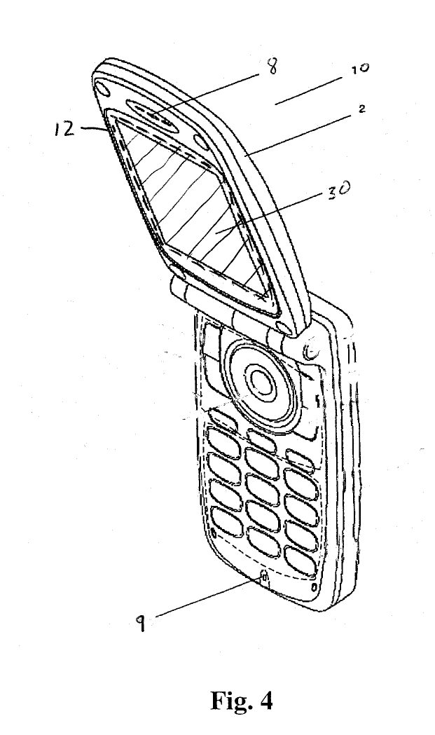

In yet another embodiment illustrated in FIG. 4, the display 12 may be altered via application of an external reflective element 30. This external reflective element 30 is preferably in the form of a film, however, may include a strip or multiple strips of glass or plastic, if desired.

The external reflective element 30 is also preferably selectively alterable to provide either high reflectivity or substantial transparency, as desired. The reflectivity may be altered based on the application of an electric field, a magnetic field, heat or even based on an acoustic signal, as suggested above with reference to FIG. 2. The transition may be triggered by manual input of the user or based on other conditions, such as temperature, or lighting conditions, for example. A sensor (not shown) may be provided to detect lighting condition, for example, and then trigger application of the voltage or other signal that is used to alter reflectivity of the element 30. Since the external reflective element 30 is provided for external attachment to the display 12, it can be used to retrofit existing electrical devices.

While preferably provided on the outside of the display 12, the element 30 may be provided on an inner surface of the outer glass of the display 12, if desired.

In one embodiment, the external reflective element 30 may include a partially silvered mirror, or other beam splitting element. In this case, the mirror is partially coated such that it reflects approximately 70% of light received from the exterior of the device. The coating on the mirror may be increased or decreased, however, as desired, to provide the desired level of reflection. In this case, transmission of light from the LCD element 20 through the partially silvered mirror out of the device 10 is reduced to approximately 30%. Thus, in order to ensure that users can see the information displayed on the LCD element 20, the luminosity of the LCD element 20 should be substantially increased, perhaps as much as three times that of that used in a conventional device. The controller 22 may be used to direct such an increase in luminosity when needed. For example, the user may indicate that the element 30 is present and additional luminosity is preferred via the input buttons 4, for example. As noted above, the LCD element 20 may be replaced by an OLED element or any other suitable display element.

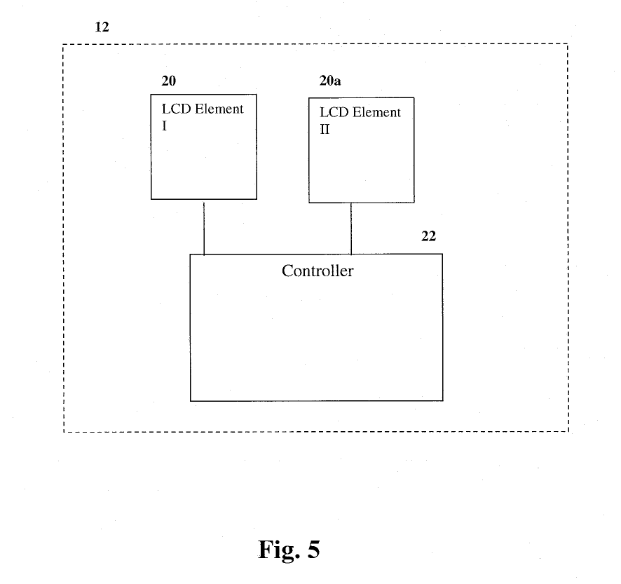

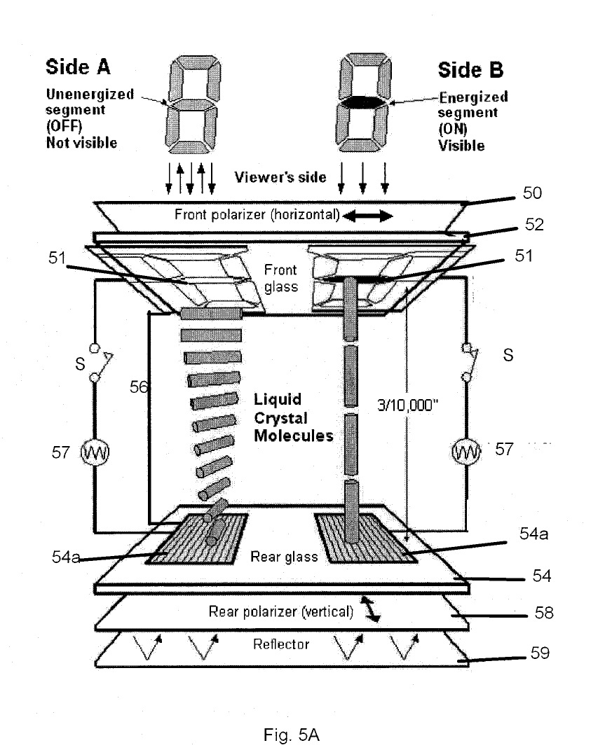

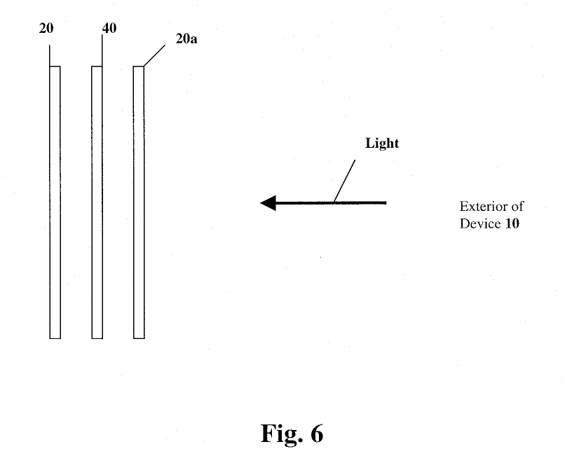

FIG. 5 illustrates another example of a display 12 that may be used in an electrical device 10 similar to that described above with reference to FIG. 1, for example. The display 12 preferably includes a first LCD element 20 and a second LCD element 20a with a partially silvered mirror 40 positioned between the two (see FIG. 6, for example). Both elements 20 and 20a, respectively, may be replaced by an OLED element, or any other suitable display element. The partially silvered mirror 40 is preferably a passive element, and therefore is not subject to direct control by the controller 22, however, the controller 22 controls the LCD elements 20 and 20a.

The partially silvered mirror 40 may be similar to that described above with respect to the element 30. The first LCD element 20 is preferably a color LCD typically used to display information to users in electrical devices such as cell phones, laptop computers and the like. The partially silvered mirror 40 is preferably positioned in front of (closer to the user) than the first LCD element 20. The mirror 40 is coated to provide a desired amount of reflection of light received from the user side thereof, that is, from the direction indicated by the arrow in FIG. 6. As noted above, the amount of light that passes through the partially silvered mirror from the first LCD element 20 will be limited, and thus, the first LCD element may need to have an increased light output, or luminosity, to ensure that displayed information is visible to the user. The reflectivity and the translucence of the partially silvered mirror 40 may be adjusted as desired based on the amount of coating provided, for example. A second outer LCD element 20a is provided in front of the partially coated the mirror 40 and is closest to the user. This element 20a is similar to the simple LCD's used in calculators, for example, that are substantially translucent when no voltage is applied, and block light to give a black appearance when active.

FIG. 5A illustrates an exemplary embodiment of such a simple LCD, which typically includes a front, outward-facing panel 50, which provides horizontal polarization. A front glass element 52 includes segmented electrodes 51 on a rear surface thereof. A rear glass element 54 is positioned behind the front glass element and includes backplane electrodes 54a. A liquid crystal material 56 is provided between the segmented electrodes 51 and the backplane electrodes 54a. Each segment 51 is selectively connectable to a voltage source 57 via a switch S, for example. A rear polarizing panel 58 is provided behind the rear glass and provides vertical polarization. A reflector element 59 is provided behind the rear polarizer 58. The LCD is essentially transparent when not energized. That is, light enters and passes through the polarizers 50, 58, the liquid crystal material 56 and the glass elements 52,54 and reflects off the reflector 59 essentially undisturbed.

When energized, the voltage applied to each segment 51 causes the liquid crystals in the energized segment 51 to align. The crystals then block reflected light from the reflector 59 to provide a black appearance in that segment. Side A of FIG. 5A illustrates an LCD is which no segments are energized, and thus, is translucent. Side B illustrates a single segment 51 connected to voltage source 57 via switch S which results in that segment appearing black since it blocks reflectance from the reflector 59.

The simple LCD illustrated in FIG. 5A is typically thermochromic, meaning that it is temperature sensitive. It is the heat of the electrical signal provided to the energized segment 51 that results in crystal alignment. The LCD illustrated in FIG. 5A is merely exemplary and the present disclosure in not limited to use therewith.

While FIG. 5A explicitly illustrates an LCD element, as is note above, the elements 20 20a may be replaced with any suitable display element, such as an OLED element or an e-paper element.

The controller 22 preferably controls the two LCD elements 20, 20a, or other suitable display elements, to provide for three different modes of operation for the display 12. In a reflective mode, the user can use the display 12 as a mirror. In this mode, the first and second LCD elements 20, 20a are both off, or inactive, such that the reflective surface of the partially coated mirror 40 acts as a mirror for the user. In a second mode, a display mode, the first LCD element 20 is active to display information to the user and the second LCD element 20a is off such that it is substantially translucent. Thus, the information from the first LCD element 20 is visible through the partially silvered mirror 40 and the second LCD element 20a. In a blackout mode, the second LCD element 20a is active such that the display 12 appears substantially blacked out. The first LCD element 20 is preferably off.

In an alternative embodiment, the second LCD element 20a, or other display element, may be modified such that it is blacked out when no voltage is applied and is translucent when the voltage is provided. In this case, blackout mode could be provided with little to no energy consumption. In reflective mode, a voltage would be provided to the element 20a but not the element 20 such that the user can see their reflection through the element 22a from the mirror 40. In display mode, both the elements 20, 20a would be powered such that information is visible on the element 20 through the mirror 40 and the element 20a.

While not specifically shown, the electrical device 10 preferably includes a power source which provides power for the various LCD elements and reflecting or reflective elements as desired. Delivery of power may be controlled by the controller 22, or by a separate power supply controller, or both, if desired.

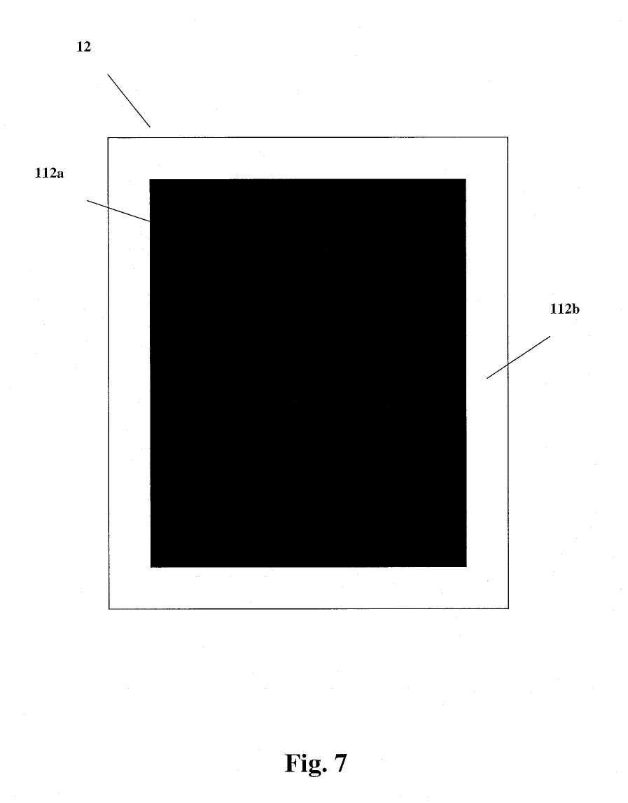

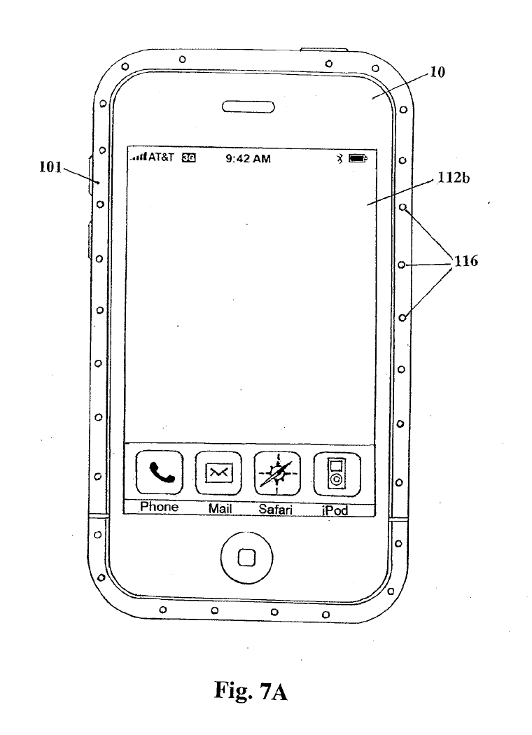

In another embodiment illustrated in FIG. 7, for example, the display 12 may simply be a conventional color LCD display as is commonly used in devices such as cellular telephones. The reflectivity of the front surface, however, may be modified based on control of the display 12 by the controller 22, for example. In this embodiment, when a more reflective surface is desired, a center, or main part 112a of the display 12 will be controlled by the controller 22 to be substantially black. A peripheral area 112b, around the periphery of this blacked out area 112a, will be lit up by the backlight of the LCD element very brightly. As a result, a user will be able to see their reflection in the blacked out area 112a of the display 12. This is much the same concept as used in conventional vanity mirrors, which are surrounded by light bulbs to increase the clarity of the individual's reflection.

In another embodiment, a plurality of additional LEDs, or other light producing elements may be provided around the periphery of display 12 in order to increase the light that shines out onto the user. This, in turn, increases the clarity of the reflection in the blacked out portion 112a of the display 12. The LEDs may be built into the device 10 during manufacture, or may be added after manufacture. In one embodiment illustrated in FIG. 7A, the additional LEDs 116 may be provided in a case or cover 101 that the device 10 may be fitted into.

In a preferred embodiment, a case or skin, 101 accommodates the electric device 10. A skin generally refers to a case that is made of a flexible and elastic material that tightly fits on the device 10. As used herein, the terms “case” and “skin” are interchangeable. The case 101 is preferably shaped to cover the sides and rear of the device 10 while including an open front so that users can see the display 12 of the device 10 when it is in the case 101. Openings may also be formed in the sides and back of the case to allow access to various input buttons 4 or ports in the device 10. The device 10 illustrated in FIG. 7A is an iPhone (iPhone is a registered trademark of Apple Inc.), however, the present application is applicable to any desired portable electronic device or other electronic device. When other devices are used, minor variations to the back and sidewalls of the case 101 may be made in order to accommodate varying configurations of input button and ports on the different devices. The LEDs 116 are preferably powered by the device 10 via a port or connector provided in the case 101. For example, a mini USB plug or port may be provided for connecting to the device 10 and providing power to the LEDs. Any suitable connector, however, may be used.

FIG. 8 illustrates another embodiment in which the device 10 is received in a case or skin 201. The case or skin 201 is similar to that of FIG. 7A, however, may not include the LEDs 116. The case 201, preferably includes reflecting element 224, which is similar to reflecting element 24 discussed above with respect to FIGS. 2-2A. The reflecting element 224 is preferably mounted in the open front of the case 201 over the display 12. In a preferred embodiment, the reflecting element 224 is powered and controlled by the device 10, for example, by the controller 22, via a mini USB plug or port that connects the case 201 to the device 10. Any suitable connection between the case and the device 10, however, may be used. In another embodiment, the reflecting element 24 may include one or more transparent solar cells formed therein which may be used to provide power. In this embodiment, the reflecting element 224 is still preferably controlled by the device 10, and preferably via controller 22 discussed above. The solar cells may be used to provide power to the device 10, if desired.

Although the present invention has been described in relation to particular embodiments thereof, many other variations and modifications and other uses will become apparent to those skilled in the art.

What is claimed is:

1. An electrical device comprises:
a controller configured and operable to control the electrical device; and
a display configured and operable to display information to the user, wherein a reflectivity of the display is increased based on operation of the controller such that the display is usable as a mirror.

2. The electrical device of claim 1, further comprising a reflecting element mounted in front of the display and controlled by the controller to selectively increase in reflectivity.

3. The electrical device of claim 2, wherein the reflecting element further comprises:
an outer transparent substrate positioned to face the user;
an outer transparent electrode positioned inward from the outer glass substrate;
a layer of variable reflective material positioned inward from the outer transparent electrode;
an inner transparent electrode positioned inward from the layer of variable reflective material; and
an inner transparent substrate positioned inward from the inner transparent electrode and facing the display;
wherein the reflectivity of the layer of variable reflective material increases based on voltage applied via the outer and inner electrodes.

4. The electrical device of claim 3, wherein the reflectivity of the variable reflective material remains increased after the voltage is removed.

5. The electrical device of claim 4, wherein the variable reflective material is a film of transition metal composition that includes magnesium.

6. The electrical device of claim 5, wherein the transition metal composition includes at least one transition metal.

7. The electrical device of claim 6, further comprising a case configured and operable to receive the electrical device and including an open front such that the display is visible to the user, wherein the reflecting element is positioned in the open front of the case in front of the display.

8. The electrical device of claim 1, wherein the display comprises a color display element.

9. The electrical device of claim 8, wherein the controller controls the display to provide a blacked out area in a middle portion of the display; and
to provide a light emitting portion surrounding a periphery of the blacked out area using light of the color display element such that a reflection of a user is visible in the blacked out portion of the display.

10. The electrical device of claim 9, further comprising a case configured and operable to receive the electrical device such that the display is visible to the user.

11. The electrical device of claim 10, wherein the case further comprises a plurality of light emitting elements positioned around a periphery of the display to emit light toward the user.

12. The electrical device of claim 8, wherein the electrical device further comprises a partially silvered mirror mounted on an outer surface of the display, wherein an amount of silver provided on the partially silvered mirror is set such that the partially silvered mirror is substantially reflective when a light of the color display element is off and is at least partially transparent to light emitted from the color display element.

13. The electrical device of claim 12, wherein the controller controls the light of the color display element to increase in luminosity when the partially silvered mirror is present, as indicated by an input from the user.

14. The electrical device of claim 12, wherein the partially silvered mirror comprises a removable foil positioned on a top surface of the display.

15. The electrical device of claim 12, further comprising an outer display element positioned on an outer surface of the partially silvered mirror.

16. The electrical device of claim 15, wherein the outer display element is controlled by the controller to selectively provide a black screen covering the partially silvered mirror.

17. A method of controlling an electrical device including a display comprises increasing a reflectivity of the display such that the display is usable as a mirror.

18. The method of claim 17, further comprising:
mounting a reflecting element in front of the display; and
controlling the reflecting element by the controller to selectively increase in reflectivity.

19. The method of claim 18, wherein the reflecting element comprises a variable reflective material that increases in reflectivity in an electric field.

20. The method of claim 17, further comprising providing a color display element as the display.

21. The method of claim 20, further comprising:
providing a blacked out area in a middle portion of the display; and
activating a light emitting portion of the display surrounding a periphery of the blacked out area to emit light such that a reflection of a user is visible in the blacked out area of the display.

22. The method of claim 21, further comprising positioning a plurality of light emitting elements around a periphery of the display and activating the plurality of light emitting elements to emit additional light on the user.

23. The method of claim 20, further comprising positioning a partially silvered mirror on a front surface of the color display element, wherein an amount of silver provided on the partially silvered mirror is set such that the partially silvered mirror is substantially reflective when a light of the color display element is off and is at least partially transparent to light emitted from the color display element.

24. A display for use in an electrical device comprises a controller to control display of information to a user on the display and to selectively increase reflectivity of the display such that the display is usable as a mirror.

25. The display of claim 24, further comprising a reflecting element mounted in front of the display and controlled by the controller to selectively increase in reflectivity.

26. The display of claim 25, wherein the reflecting element further comprises:
an outer transparent substrate positioned to face the user;
an outer transparent electrode positioned inward from the outer glass substrate;
a layer of variable reflective material positioned inward from the outer transparent electrode;
an inner transparent electrode positioned inward from the layer of variable reflective material; and
an inner transparent substrate positioned inward from the inner transparent electrode and facing the display;
wherein the reflectivity of the layer of variable reflective material increases based on voltage applied via the outer and inner electrodes.

27. The display of claim 26, wherein the reflectivity of the variable reflective material remains increased after the voltage is removed.

28. The display of claim 27, wherein the variable reflective material is a film of transition metal composition that includes magnesium.

29. The display of claim 28, wherein the transition metal composition includes at least one transition metal.

30. The display of claim 29, further comprising a case configured and operable to receive the electrical device and including an open front such that the display is visible to the user, wherein the reflecting element is positioned in the open front of the case in front of the display.

31. The display of claim 24, further comprising a color display element.

32. The display of claim 31, wherein the controller controls the display to provide a blacked out area in a middle portion of the display; and
to provide a light emitting portion surrounding a periphery of the blacked out area using light of the color display element such that a reflection of a user is visible in the blacked out area of the display.

33. The display of claim 32, further comprising a case configured and operable to receive the electrical device such that the display is visible to the 100 user.

34. The display of claim 33, wherein the case further comprises a plurality of light emitting elements positioned around a periphery of the display to emit light toward the user.

35. The display of claim 31, further comprising:
a partially silvered mirror mounted on an outer surface of the display;
wherein an amount of silver provided on the partially silvered mirror is set such that the partially silvered mirror is substantially reflective when a light of the color display element is off and is at least partially transparent to light emitted from the color display element.

36. The display of claim 35, wherein the controller controls the light of the color display element to increase luminosity when the partially silvered mirror is present as indicated by an input from the user.

37. The display of claim 35, wherein the partially silvered mirror comprises a removable foil positioned on a top surface of the display.

38. The display of claim 35, further comprising an outer display element positioned on an outer surface of the partially silvered mirror.

39. The display of claim 38, wherein the outer display element is controlled by the controller to selectively provide a black screen covering the partially silvered mirror.
